(19) United States
(12) Patent Application Publication
(10) Pub. No.: US 2025/0217137 A1
(43) Pub. Date: Jul. 3, 2025

(54) METHOD AND SYSTEM FOR DETERMINING TARGET ELEMENTS FROM FUNCTIONALITIES OF MONOLITHIC APPLICATIONS

(71) Applicant: HCL Technologies Limited, New Delhi (IN)

(72) Inventors: Jomin Joy, Chennai (IN); Hareendran M, Chennai (IN); Maheswari V.S, Chennai (IN)

(21) Appl. No.: 19/008,515

(22) Filed: Jan. 2, 2025

(30) Foreign Application Priority Data
Jan. 3, 2024 (IN) 202411000615

(51) Int. Cl. G06F 8/73

(52) U.S. Cl. CPC G06F 8/73

(57) ABSTRACT

This disclosure relates to method and system for determining target elements from a functionality of a monolithic application. The method includes extracting a set of process elements and a set of data elements from the functionality of the monolith application. The method further includes determining a Functionality Association (FA) score for each element of the set of process elements based on a first set of predefined attributes, and each element of the set of data elements based on a second set of predefined attributes. The method further includes assigning a category from a plurality of categories to the each element of the set of process elements and the each element of the set of data elements based on the FA score and pre-defined threshold ranges. Further, the method includes determining the target elements based on the assigned category.

### TECHNICAL FIELD

This disclosure relates generally to the field of software development life cycle, and more particularly to method and system for determining target elements from a functionality of a monolithic application.

### BACKGROUND

Today, a demand for sophisticated software applications has grown. Therefore, developers have increasingly opted for monolithic architectures due to their simplicity and ease of initial development. Monolithic applications encapsulate various functionalities within a single, interconnected structure, making them convenient for deployment. In other words, the monolithic applications represent a common architecture where all application components, functionalities, and services are tightly integrated into a single, cohesive unit. Even if the monolithic applications are favoured for their simplicity and ease of deployment, they often pose challenges when it comes to maintaining, scaling, or extracting specific functionalities for various purposes, such as modularization, migration to microservices, or refactoring.

In traditional monolithic applications, the interdependence of functionalities within a single codebase makes it difficult to isolate specific elements for updates or modifications without impacting an entire application. One significant challenge arises when developers need to modify or update specific functionalities within a monolithic application without impacting the entire system. Traditional methods often involve extensive manual efforts to identify and extract target/core elements related to a particular functionality. These methods are time-consuming, error-prone, and do not provide a comprehensive understanding of the interdependencies and complexities within the monolithic application. Automated tools designed to identify functionalities within monolithic applications may fall short in accurately determining the target/core elements, leading to inefficiencies and potential errors during the development process.

Moreover, as monolithic applications grow in complexity over time, it becomes increasingly crucial to automate the process of identifying and isolating target elements within the application codebase. The present invention is directed to overcome one or more limitations stated above or any other limitations associated with the known arts.

### SUMMARY

In one embodiment, a method for determining target elements from a functionality of a monolithic application is disclosed. In one example, the method may include extracting a set of process elements and a set of data elements from the functionality of the monolith application. The method may further include determining a Functionality Association (FA) score for each element of the set of process elements based on a first set of predefined attributes, and each element of the set of data elements based on a second set of predefined attributes. The method may further include assigning a category from a plurality of categories to each element of the set of process elements and each element of the set of data elements based on the FA score and pre-defined threshold ranges. The method may further include determining the target elements based on the assigned category.

In another embodiment, a system for determining target elements from a functionality of a monolithic application is disclosed. In one example, the system may include a processor and a memory communicatively coupled to the processor. The memory may store processor-executable instructions, which, on execution, cause the processor to extract a set of process elements and a set of data elements from the functionality of the monolith application. The processor-executable instructions, on execution, may further cause the processor to determine a Functionality Association (FA) score for each element of the set of process elements based on a first set of predefined attributes, and each element of the set of data elements based on a second set of predefined attributes. The processor-executable instructions on execution may further cause the processor to assign a category from a plurality of categories to each element of the set of process elements and each element of the set of data elements based on the FA score and pre-defined threshold ranges. The processor-executable instructions, on execution, may further cause the processor to determine the target elements based on the assigned category.

In yet another embodiment, a non-transitory computer-readable medium storing computer-executable instructions for determining target elements from a functionality of a monolithic application is disclosed. In one example, the stored instructions, when executed by a processor, may cause the processor to perform operations including extracting a set of process elements and a set of data elements from the functionality of the monolith application. The operations may further include determining a Functionality Association (FA) score for each element of the set of process elements based on a first set of predefined attributes, and each element of the set of data elements based on a second set of predefined attributes. The operations may further include assigning a category from a plurality of categories to each element of the set of process elements and each element of the set of data elements based on the FA score and pre-defined threshold ranges. The operations may further include determining the target elements based on the assigned category.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for determining target elements from a functionality of a monolithic application, in accordance with some embodiments.

FIG. 2 is a functional block diagram of an exemplary computing device, in accordance with some embodiments.

FIG. 3 illustrates a flow diagram of an exemplary process for determining target elements from a functionality of a monolithic application, in accordance with some embodiments.

FIG. 4 illustrates a flow diagram of an exemplary process for determining target elements based on categories assigned to process elements and data elements, in accordance with some embodiments.

FIG. 5A illustrates an exemplary scenario for extraction of process elements and data elements from a functionality of a monolithic application, in accordance with some embodiments.

FIGS. 5B and 5C illustrate exemplary tables generated during determination of target elements from a functionality of a monolithic application, in accordance with some embodiments.

FIG. 6 illustrates an exemplary functional flow for a functionality of a monolithic application, in accordance with some embodiments.

FIG. 7 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

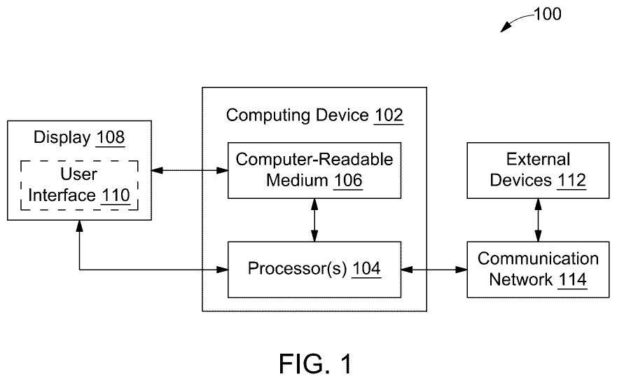

Referring now to FIG. 1, an exemplary system 100 for determining target elements from a functionality of a monolithic application is illustrated, in accordance with some embodiments. The system 100 may implement a computing device 102 (for example, a desktop, a laptop, a notebook, a netbook, a tablet, a smartphone, a mobile phone, or any other computing device), in accordance with some embodiments of the present disclosure. The computing device 102 may determine the target elements from the functionality of the monolithic application. As will be appreciated to a person skilled in the art, the monolithic application corresponds to a software architecture where all components and features are tightly integrated into a single, cohesive unit.

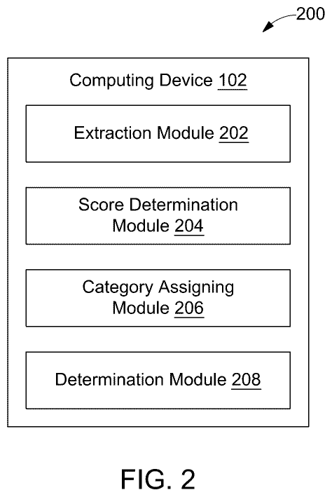

As will be described in greater detail in conjunction with FIGS. 2-7, the computing device 102 may extract a set of process elements and a set of data elements from the functionality of the monolith application. The set of process elements and the set of data elements are extracted through an automated crawling technique. The set of process elements includes code snippets responsible for controlling an execution flow of processing the functionality. The set of data elements includes entities within the code snippets. The computing device 102 may further determine a Functionality Association (FA) score for each element of the set of process elements based on a first set of predefined attributes, and each element of the set of data elements based on a second set of predefined attributes. The first set of predefined attributes includes a Line of Code (LOC), a comment density, a cyclomatic complexity, a data artifact affinity, a data input, a data output, a frequency of invocations, element dependencies, annotations, technical dependencies, a number of classes, a frequency of changes, a historical analysis, and a documentation. Further, the second set of predefined attributes includes an association of data elements with the functionality, a level of ownership of the functionality with data elements, and dependencies among data elements. The computing device 102 may further assign a category from a plurality of categories to the each element of the set of process elements and the each element of the set of data elements based on the FA score and pre-defined threshold ranges. The plurality of categories includes a reutilization category, a modification category, and a removal category. The computing device 102 may further determine the target elements based on the assigned category. The computing device 102 is further explained in detail in conjunction with FIG. 2.

In some embodiments, the computing device 102 may include one or more processors 104 and a computer-readable medium 106 (for example, a memory). The computer-readable medium 106 may include a database (not shown in FIG. 1). The memory may be a non-volatile memory (e.g., flash memory, Read Only Memory (ROM), Programmable ROM (PROM), Erasable PROM (EPROM), Electrically EPROM (EEPROM) memory, etc.) or a volatile memory (e.g., Dynamic Random Access Memory (DRAM), Static Random-Access memory (SRAM), etc.)

Further, the computer-readable medium 106 may store instructions that, when executed by the one or more processors 104, cause the one or more processors 104 to determine target elements from the functionality of the monolithic application. The computer-readable medium 106 may also store various data (for example, the first set of attributes, the second set of attributes, FA score, data elements, process elements, and the like) that may be captured, processed, and/or required by the system 100.

The system 100 may further include a display 108. The system 100 may interact with a user via a user interface 110 accessible via the display 108. In some embodiments, the monitoring device 102 may render results to the user via the user interface 110. The system 100 may also include one or more external devices 112. In some embodiments, the computing device 102 may interact with the one or more external devices 112 over a communication network 114 for sending or receiving various data. The communication network 114, for example, may be any wired or wireless communication network and the examples may include, but may be not limited to, the Internet, Wireless Local Area Network (WLAN), Wi-Fi, Long Term Evolution (LTE), Worldwide Interoperability for Microwave Access (WiMAX), and General Packet Radio Service (GPRS). The external devices 112 may include, but may not be limited to, a remote server, a digital device, a desktop, a laptop, a notebook, a netbook, a tablet, a smartphone, a mobile phone, or another computing system.

Referring now to FIG. 2, a functional block diagram of an exemplary computing device (analogous to the computing device 102) is illustrated, in accordance with some embodiments. FIG. 2 is explained in conjunction with FIG. 1. The computing device 102 may identify a core set of elements of the functionality from the monolith application which may be transformed to a target format as per the demand. This computing device 102 extends idea of analysis to code block and data element level, which is granular and import in increasing the accuracy of the overall analysis. The computing device 102 includes an extraction module 202, a score determination module 204, a category assigning module 206, and a determination module 208. In some embodiments, the modules 202-208 may be within the memory of the computing device 102. The computing device 102 may also include a datastore (not shown in FIG. 2) to store various data and intermediate results generated through the modules 202-208.

In some embodiments the extraction module 202 may identify all elements (for example, a set of process elements and a set of data elements) of the functionality. The extraction module 202 may be configured to extract the set of process elements and the set of data elements from the functionality of the monolith application. The set of process elements includes code snippets responsible for controlling an execution flow of processing the functionality. The set of data elements includes entities within the code snippets. It should be noted that the set of process elements and the set of data elements are extracted through an automated crawling technique. The element extraction module 202 may use an automated method, for example a crawler or a similar tool, to traverse through monolithic application's codebase systematically.

In simpler words, for each functionality of the monolithic application, the extraction module 202 may extract associated process elements (i.e. elements within the set of process elements) and data elements (i.e., elements within the set of data elements) using the automated crawling technique. It should be noted that the process elements are code blocks involved in a control flow while processing the functionality. The process elements consume different entities, objects, or variables. Further, the data elements are data artifacts involved in the processing. Elements in the data artifacts associated with the entities, the objects, the variables may be collected as the data elements associated with the functionality. The data elements may be, but are not limited to, a set of configuration or properties in configuration and property files, one or more attributes or one or more columns of a table involved in database queries.

Further, the score determination module 204 may be configured to determine a Functionality Association (FA) score for each element of the set of process elements based on a first set of predefined attributes, and each element of the set of data elements based on a second set of predefined attributes. For example, the first set of predefined attributes includes a Line of Code (LOC), a comment density, a cyclomatic complexity, a data artifact affinity, a data input, a data output, a frequency of invocations, element dependencies, annotations, technical dependencies, a number of classes, a frequency of changes, a historical analysis, and a documentation. Further, the second set of predefined attributes includes an association of data elements with the functionality, a level of ownership of the functionality with data elements, and dependencies among data elements. It should be noted that the FA Score of each element is determined to identify target elements/the core elements of the functionality.

Further, the FA score of the each of the set of data elements may be calculated based on an element type specific characteristic. To determine the FA score of each element of the set of data elements of the functionality, an analysis may be performed based on the association of at least one of entities, objects or variables with the functionality, a level of ownership of the functionality with the data elements, and a dependencies among the data elements. The association of at least one of entities or objects or variables with the functionality may be from 1 to 10, where 1 being the lowest association and 10 being the highest association. It should be noted that the calculated FA score is normalized to 0 to 1. The FA score may be calculated based on equation (1) given below:

$${( Data Element FA Score )}_{DE , i} = {( Association Score )}_{DE , i} * {( Level of Ownership )}_{DE , i} + {( Elements Dependancy Score )}_{DE , i} \qquad equation ( 1 )$$

By way of an example, further, the level of ownership may be categorised as, an owner and consumer, an owner and consumer outside, a consumer but not an owner, neither a consumer nor an owner. In an exemplary embodiment, the owner and consumer category may include data elements which may be created and consumed inside functionalities (for example, state-management and trackability information). The owner and consumer outside category may include data elements which may be created or updated inside but consumed outside (for example, in banking system, deposit functionality may be updating or creating a passbook entry, which may be consumed by functionalities like “Balance Enquiry”). Further, the consumer but not an owner category may include data elements which may be created or updated outside the functionalities but consumed internally (for example, in banking system, “Balance Enquiry.” functionality consumes passbook entry without any update or addition). The neither consumer nor owner category may include data elements which are not created or updated inside the functionalities nor consumed internally (for example, in a table, there may be many columns that are not touched by a given functionality). In simpler words, in a typical application environment configuration of property files may be used by many functionalities. All properties/configurations may not be related to the given functionality. Therefore, it is important to identify fields, the properties, or the configurations associated with functionalities and prioritize those based on their usage.

Moreover, the FA score of each element of the set of process elements may identify closeness of an element with the functionality or a business functionality. The FA score may be from 0 to 100 on the closeness, where 100 being the highest and 0 being the lowest. Each type of elements may have its own characteristic and metrics to calculate the FA score. The FA score of each code block ‘i’ for the process element ‘E’ is calculated as per equation (2), given below:

$${( Block FA Score )}_{E , i} = {( LOC Score )}_{E , i} + {( Comment Density Score )}_{E , i} + {( Cyclomatic Complexity Score )}_{E , i} + {( Data Artifact Affinity Score )}_{E , i} + {( Tech Dependency )}_{E , i} + {( Frequency of Invocations Score )}_{E , i} + {( Block Dependencies Score )}_{E , i} + {( Annotations Score )}_{E , i} + {( Frequency of Changes Score )}_{E , i} + {( Data Input Score )}_{E , i} + {( Data Output Score )}_{E , i} + {( Docummentation Score )}_{E , i} \qquad equation ( 2 )$$

It should be noted that each element of the set of process element and the set of data elements has its unique characteristics and matrices to calculate the FA score. In an exemplary embodiment, Lines of Code (LOC) or an LOC score may provide an indication of complexity and significance of a block/code block. Longer code blocks may involve more intricate business logic or perform more critical operations, which may contribute to a higher business impact. The LOC of each of code blocks is calculated and normalized across the process elements of the given functionality and multiplied with its corresponding weightage ‘W_{E,1}’ to get LOC score of a code block ‘i’. The weights reflect their relative importance in determining individual contribution of a metric to the FA score of an element of the set of process elements. The LOC score may be calculated as per equation (3), given below:

$${( LOC Score )}_{E , i} = {( Normalized LOC )}_{E , i} \times {W}_{E , 1} \qquad equation ( 3 )$$

Further, a comment density score may refer to a proportion of comments (including documentation, explanations, or annotations) within the codebase compared to actual lines of code. Inclusion of comment density as a parameter may help assess a level of documentation and explanatory information available for each code block. It should be noted that well-documented code blocks are often indicative of business rules or a critical logic. The comment density score may be calculated as per equation (4), given below:

$${( Comment Density Score )}_{E , i} = {( Normalized Comment Density )}_{E , i} \times {W}_{E , 2} \qquad equation ( 4 )$$

A cyclomatic complexity score may be a software matric that may measure the complexity of the code block by counting a number of linearly independent paths through its control flow graph. This parameter may also help identify a presence of the intricate business logic or decision-making processes. The cyclomatic complexity score may be calculated as per equation (5), given below:

$${( Cyclomatic Complexity Score )}_{E , i} = {( Normalized Cyclomatic Complexity )}_{E , i} \times {W}_{E , 3} \qquad equation ( 5 )$$

Further, a data element affinity score associated with table data elements may be calculated, objects which may be the instantiations of these entities may be recorded within the code block. Whenever fields of the objects are called, their corresponding FA scores may be summed up. Also, whenever there is a query with other data elements within the code block, their corresponding FA score may be summed up along with the above. This total score for the code block is divided by a maximum score of all the code blocks to get ae normalized data element affinity score. The normalized data element affinity score may by multiplied by its corresponding weightage to get the data artifact affinity score as per equation (6), given below:

$${( Data Element Affinity Score )}_{E , i} = {( Normalized Data Element Affinity )}_{E , i} \times {W}_{E , 4} \qquad equation ( 6 )$$

Further, a frequency of invocation in the execution flow may impact a business impact score in several ways. Blocks/code blocks that are frequently invoked are more likely to have a higher impact on the functionality/business functionality. For example, if a block/code block is called multiple times throughout the codebase, it suggests that its functionality may be crucial for business processes or decision-making. Assignment of a higher score to frequently invoked blocks/code blocks may reflect their significance in implementing business rules. Frequent invocations may also suggest that block's/code block's performance is critical for overall application performance. Blocks/code blocks that are called frequently should be efficient and optimized, as they may affect responsiveness and efficiency of business operations. A frequency of invocations score may be calculated as per equation (7), given below:

$${( Frequency of Invocations Score )}_{E , i} = {( Normalized Freq . of Invocations )}_{E , i} \times {W}_{E , 5} \qquad equation ( 7 )$$

Further, a block dependency score may be referred to a block's/code block's reliance on other blocks/code blocks, classes, or frameworks, and may impact the FA score. The block dependency score may be calculated as per equation (8), given below:

$${( Block Dependency Score )}_{E , i} = {( Normalized Block Dependency )}_{E , i} \times {W}_{E , 6} \qquad equation ( 8 )$$

Further, the block dependency score may impact FA score calculations due to a plurality of factors that m discussed further. In an embodiment, the block dependency score may impact the FA score calculations by a business logic flow. The block dependency score may be affected by analyzing a plurality of dependencies of the code block to understand its role in the overall business logic flow. The code block that depends on other methods or classes directly involved in implementing business rules may be likely to have a higher business impact. It should be noted that assignment of a higher score to the code blocks with significant dependencies may capture their importance in executing critical business logic.

Also, the block dependency score may impact the FA score calculations by a flow and transformation of business data. The block dependency score may be affected by considering how dependencies may contribute to the flow and transformation of business data. The Code blocks that rely on other methods or classes to receive, process, or transform business data may indicate their involvement in implementing business rules. Further, assignment of a higher score for complex data flow and transformation dependencies may reflect their impact on business operations.

Additionally, the block dependency score may impact the FA score calculations by an integration with business frameworks. The block dependency score may be affected if the code block depends on specific business frameworks or external libraries that may be essential for business processes. Further, it may suggest its relevance in implementing business rules. Further, it should be noted that assignment of a higher score to artifacts with significant dependencies on business-specific frameworks may capture their impact on business functionality.

Moreover, the block dependency score may impact the FA score calculations by a critical external dependencies. The block dependency score may be affected by evaluating the dependencies of an artifact on external systems or services that are critical for business operations. An artifact that relies on external Application Programming Interfaces (APIs), databases, or services may have a higher business impact, as they are involved in integrating and interacting with crucial business components. Further, assignment of a higher score to artifacts with dependencies on the critical external systems may reflect their significance in supporting business rules.

Further, if data which is going into the element are related to business entities or critical data for business operations, it may be suggested that the element is involved in implementing the business rules. A greater data count suggests intricate functionality, potentially impacting multiple rules. A data input score may be calculated as per equation (9), given below:

$${( Data Input Score )}_{E , i} = {( Method Parameters Score )}_{E , i} = {( Normalized Method Parameters )}_{E , i} \times {W}_{E , 7} \qquad equation ( 9 )$$

Further, a data output score may refer to a type of data coming out of the block/code block, like business entities, elevates the score, underlining its direct role in rule execution. The data output score may be calculated as per equation (10), given below:

$${( Data Output Score )}_{E , i} = {( Method Return Type Score )}_{E , i} = {( Normalized Method Return Type )}_{E , i} \times {W}_{E , 8} \qquad equation ( 10 )$$

Further, a frequency of changes to an element may affect the business impact score by indicating its dynamic nature and potential significance in the business operations. The frequency of changes score may be calculated as per equation (11), given below:

$${( Frequency of Changes Score )}_{E , i} = {( Normalized Frequency of Changes )}_{E , i} \times {W}_{E , 9} \qquad equation ( 11 )$$

Further, the frequency of changes may impact FA score calculations due to a plurality of factors as discussed further. In an embodiment, the frequency of changes may impact the FA score calculations by a business relevance. The frequency of changes may be affected by code blocks that may undergo frequent changes are more likely to be related to evolving business requirements, rules, or processes. Further, assigning a higher score to the frequently changed code blocks may reflect their importance in adapting to business needs and supporting ongoing business operations.

Further, the frequency of changes may impact the FA score calculations by agility and responsiveness. The frequency of changes may be affected by the code blocks that may be frequently modified, suggesting a need for agility and responsiveness in addressing business changes or customer requirements. Such code blocks may have a higher business impact due to their active role in adapting and accommodating evolving business scenarios. It should be noted that assigning a higher score to the frequently changed code blocks may capture their contribution to business agility.

Further, the frequency of changes may impact the FA score calculations by maintenance and bug fixes. The frequency of changes may be affected by the code blocks that may require frequent changes for maintenance, bug fixes, or performance improvements may indicate their impact on business operations. It may be noted that assigning a higher score to the code blocks that frequently undergo maintenance changes may reflect their significance in maintaining business functionality and reliability.

Further, business-specific annotations may enhance the FA score of the process elements, indicating the method's relevance to critical rules. The business-specific annotations highlight integration with business technologies. Annotations related to security or compliance boost scores, reflects rule enforcement. Annotations also aid understanding, contributing to a higher score. The annotations score may be calculated as per equation (12), given below:

$${( Annotations Score )}_{A 2 , i} = {( Normalized Annotations Score )}_{E , i} \times {W}_{E , 10} \qquad equation ( 12 )$$

Further, well-documented process elements with clear explanations and examples may enhance understanding and maintainability. These elements may include core business rules of the functionality. The documentation score may be calculated as per equation (13), given below:

$${( Documentation Score )}_{E , i} = {( Normalized Documentation Score )}_{E , i} \times {W}_{E , 11} \qquad equation ( 13 )$$

Further, a tech dependency score may decide affinity of the block/code block with tech stack of source platform of the block/code block. In case where the block/code block has tech stack related elements, which needs to be updated if a target platform is different, this block/code block needs to be rewritten or refactored for the target platform. Tech dependency may be identified through source technology specific patterns scrawling of the block/code block. The tech dependency score may be calculated as per equation (14), given below:

$${( Tech Depedancy Score )}_{E , i} = {( Normalized Tech Dependancy )}_{E , i} \times {W}_{E , 12} \qquad equation ( 14 )$$

It should be noted that FA score of all the elements of the set of data elements and the set of process elements for the functionality may be consolidated for the further processing. Further, the category assigning module 206 may be configured to assign a category from a plurality of categories to the each element of the set of process elements and the each element of the set of data elements based on the FA score and pre-defined threshold ranges. In an exemplary embodiment, the plurality of categories includes a reutilization category, a modification category, and a removal category.

In one example, the category assigning module 206 may assign a category as the reutilization category to one or more process elements and one or more data elements with high FA scores and when the FA scores of the one or more process elements and the one or more data elements is between a first pre-defined threshold range of FA score. Further, in one example, the category assigning module 206 may assign a category as the modification category to one or more data elements and one or more process elements with low FA scores and when the FA scores of the one or more process elements and the one or more data elements is between a second pre-defined threshold range of the FA score. Further, the category assigning module 206 may assign a category as the removal category to one or more data elements and one or more process elements with lowest FA scores and when the FA scores of the one or more process elements and the one or more data elements is between a third pre-defined threshold range of the FA score.

For example, the first pre-defined threshold range is 80≤FA score≤100, the second predefined threshold range is 40≤FA score<80, and the third predefined threshold range is 0≤FA score<40. For such pre-defined threshold ranges, when a data element or a process element has an FA score of “90”, the reutilization category may be assigned to that data element or the process element. Further, when a data element or a process element has an FA score of “70”, the modification category may be assigned to that data element or the process element, and when a data element or a process element has an FA score of “10”, the removal category may be assigned to that data element or the process element.

In some embodiments, data elements and process elements with the modification category may be modified by the computing device 102 and data elements and process elements with the removal category may be removed by the computing device 102 while determining target elements and to optimize the associated functionality of the monolithic application.

Further, in some embodiments, the determination module 208 may be configured for determining the target elements based on the assigned category. The target elements may include data elements and process elements with the reutilization category, and the modification category. In some embodiments, the determination module 208 may select the data elements and the process elements with the reutilization category and the modification category and discard the data elements and the process elements with the removal category. Further, the determination module 208 may modify the data elements and the process elements which have the modification category, for improvement of business functionalities of the monolith application. Further, the determination module 208 may replace the discarded data elements and the process elements with one or more new data elements and process elements to determine the target elements. It should be noted that the determination module 208 may add the one or more new data elements and the process elements to the existing monolithic application to better optimize flow of the functionalities of the monolithic application. Additionally, in some embodiments, a functional flow for the functionality with the target elements, based on element dependencies. It should be noted that multiple occurrences of a target element are permitted in the functional flow. Further, the target elements may be transformed into one or more formats of one or more target platforms based on the functional flow. The target platform may be a micro service, serverless functions, etc. The business elements/target elements need to be converted according to syntax to the target platform along with necessary non-functional requirement (NFR) for the final deployment.

It should be noted that the system 100 and associated computing device 102 may be implemented in programmable hardware devices such as programmable gate arrays, programmable array logic, programmable logic devices, or the like. Alternatively, the system 100 and computing device 102 may be implemented in software for execution by various types of processors. An identified engine/module of executable code may, for instance, include one or more physical or logical blocks of computer instructions which may, for instance, be organized as an object, module, procedure, function, or other construct. Nevertheless, the executables of an identified engine/module need not be physically located together but may include disparate instructions stored in different locations which, when joined logically together, comprise the identified engine/module and achieve the stated purpose of the identified engine/module. Indeed, an engine or a module of executable code may be a single instruction, or many instructions, and may even be distributed over several different code segments, among different applications, and across several memory devices.

As will be appreciated by one skilled in the art, a variety of processes may be employed for determining target elements from a functionality of a monolithic application. For example, the exemplary system 100 and the associated computing device 102 may determine the target elements from the functionality of the monolithic application by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors 104 on the system 100 and the associated computing device 102 to perform some or all of the techniques described herein. Similarly, application specific integrated circuits (ASICs) configured to perform some, or all of the processes described herein may be included in the one or more processors 104 on the system 100 and the associated computing device 102.

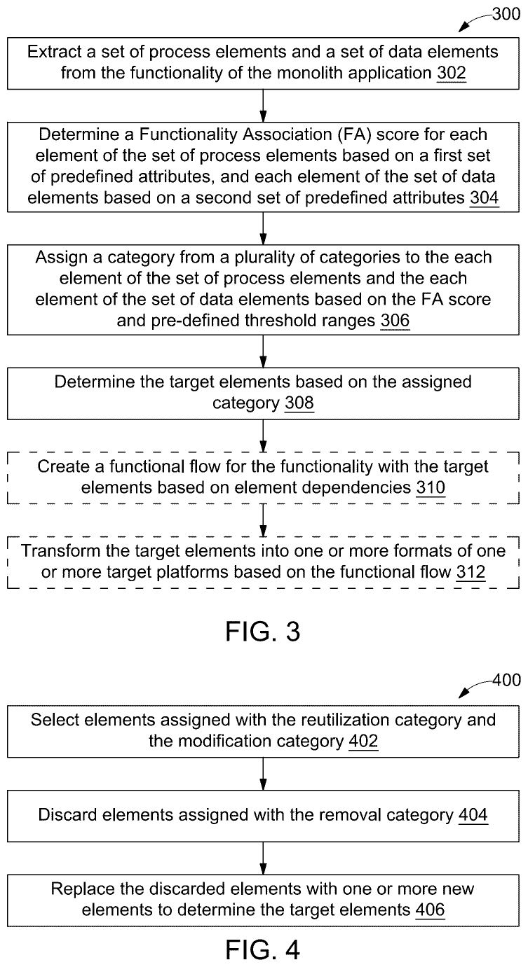

Referring now to FIG. 3, an exemplary process 300 for determining target elements from a functionality of a monolithic application is depicted via a flowchart, in accordance with some embodiments. FIG. 3 is explained in conjunction with FIGS. 1-2. Each step of the process 300 may be implemented by the computing device 102.

At step 302, a set of process elements and a set of data elements may be extracted from the functionality of the monolith application through the extraction module 202. The set of process elements may include code snippets responsible for controlling an execution flow of processing the functionality. the set of data elements may include entities within the code snippets. It should be noted that the set of process elements and the set of data elements may be extracted through an automated crawling technique. For example, a crawler or a similar tool may be used to traverse through monolithic application's codebase systematically.

It should be noted that the process elements are code blocks involved in a control flow while processing the functionality. The process elements consume different entities, objects, or variables. Further, the data elements are data artifacts involved in the processing. Elements in the data artifacts associated with the entities, the objects, the variables may be collected as the data elements associated with the functionality. The data elements may be, but are not limited to, a set of configuration or properties in configuration and property files, one or more attributes or one or more columns of a table involved in database queries.

At step 304, a Functionality Association (FA) score may be determined for each element of the set of process elements based on a first set of predefined attributes, and each element of the set of data elements based on a second set of predefined attributes. This step may be performed using the score determination module 204. The first set of predefined attributes may include a Line of Code (LOC), a comment density, a cyclomatic complexity, a data artifact affinity, a data input, a data output, a frequency of invocations, element dependencies, annotations, technical dependencies, a number of classes, a frequency of changes, a historical analysis, and a documentation. Further, the second set of predefined attributes may include an association of data elements with the functionality, a level of ownership of the functionality with data elements, and dependencies among data elements. This has already been explained in conjunction with FIG. 2.

Thereafter, at step 306, a category from a plurality of categories may be assigned to each element of the set of process elements and the each element of the set of data elements based on the FA score and pre-defined threshold ranges. This step may be performed through the category assigning module 206. The plurality of categories includes a reutilization category, a modification category, and a removal category. The pre-defined threshold ranges may include a first pre-defined range, a second pre-defined range, and a third pre-defined range. For example, the first pre-defined range is 80≤FA score≤100, the second predefined threshold range is 40≤FA score<80, and the third predefined threshold range is 0≤FA score<40. For such pre-defined threshold ranges, when a data element or a process element has a FA score of “80”, the reutilization category may be assigned to that data element or the process element as the FA score “80” lies in the first predefined threshold range 80≤FA score≤100. Further, when a data element or a process element has a FA score of “60”, the modification category may be assigned to that data element or the process element, as the FA score “60” lies in the second predefined threshold range 40≤FA score<80, and when a data element or a process element has a FA score of “20”, the removal category may be assigned to that data element or the process element as the FA score “20” lies in the third predefined threshold range 0≤FA score<40. Here, for brevity, one example of the predefined threshold ranges has been explained, however the disclosure may be applicable for other predefined threshold ranges as well.

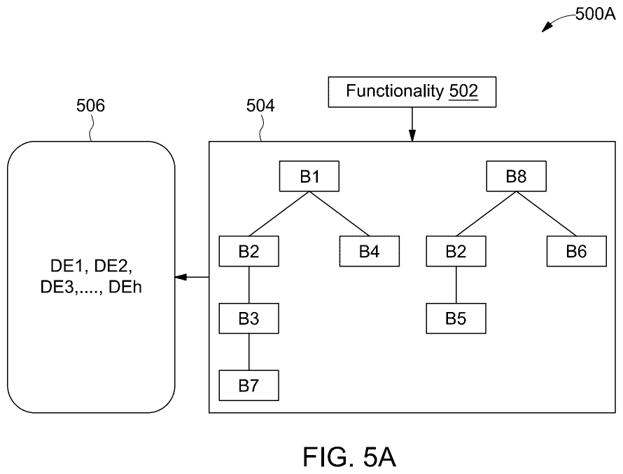

At step 308, the target elements may be determined based on the assigned category through the determination module 208. The target elements may include data elements and process elements with the reutilization category and the modification category, and one or more new data elements and process elements added in place of data elements and process elements with the removal category. This is further explained in conjunction with FIG. 4.

At step 310, a functional flow may be created for the functionality with the target elements based on element dependencies. It should be noted that the multiple occurrences of a target element are permitted in the functional flow. The functional flow may represent the functionality of the monolithic application with the target elements.

Thereafter, at step 312, the target elements may be transformed into one or more formats of one or more target platforms based on the functional flow. The target platform may be a micro service, serverless functions, etc. The business elements/target elements need to be converted according to syntax to the target platform along with necessary non-functional requirement (NFR) for the final deployment.

Referring now to FIG. 4, an exemplary process 400 for determining the target elements based on categories assigned to process elements and data elements is depicted via a flowchart, in accordance with some embodiments. FIG. 4 is explained in conjunction with FIGS. 1-3. Each step of the process 400 may be implemented by the determination 208.

At step 402, elements assigned with the reutilization category and the modification category may be selected. The elements of the reutilization category are used as it is in the functional flow of the monolithic application. The elements of the modification category may be modified based on required functional flow of the functionality of the monolithic application. The modification may include editing an existing element.

At step 404, elements assigned with the removal category may be discarded. The elements assigned the removal category are least associated with a given functionality.

At step 406, the discarded elements may be replaced with one or more new elements to determine the target elements. It should be noted that the discarded elements are replaced with the target elements to better optimize the functional flow of the functionality of the monolithic application.

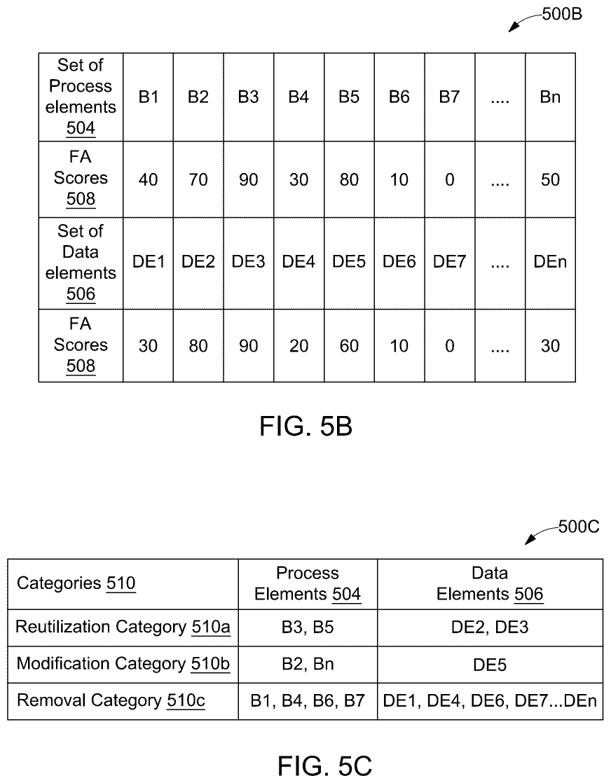

Referring now to FIG. 5A, an exemplary scenario 500A for extraction of process elements and data elements from a functionality 502 of a monolithic application is illustrated, in accordance with some embodiments. FIG. 5A is explained in conjunction with FIGS. 1-4. In an embodiment, the monolithic application may include the functionality 502 which may further include a set of process elements 504 and a set of data elements 506. As illustrated in FIG. 4A, the set of process elements 504 are B1, B2, B3 . . . Bg and the set of data elements 506 are DE1, DE2, DE3 . . . DEh. The set of process elements 504 and the set of data elements 506 of the functionality 502 may be identified and extracted by crawling all elements in an execution flow of the functionality 502.

In an exemplary embodiment, each of the set of process elements 504 is a code block involved in a control flow while processing the functionality 502. For the functionality 502, the set of process elements 504 (for example, B1, B2, B3 . . . Bg) are individual blocks of code that perform specific tasks or operations. Further, each of the set of data elements 506 is a data artifact involved in processing of the functionality 502. In some embodiments, the set of process elements 504 consume different entities, objects, or variables. The set of data elements 506 in data artifacts associated with these entities, objects, variables are collected as the set of data elements 506 associated with the functionality 502.

By way of an example, consider that the monolithic application is a banking application. The banking application includes a plurality of functionalities (for example, a balance enquiry, a net banking operation, etc.). Further, a user may use the balance enquiry as the functionality 502 of the banking application. In such a case, an automatic crawler may start crawling an execution flow of the balance enquiry functionality. The automatic crawler may identify and extract process elements (for example, the set of process elements 504) and data elements (for example the set of data elements 506) of the balance enquiry functionality (for example, the functionality 502). The extracted process elements of the balance enquiry functionality may include a code block for navigating to the balance enquiry in the banking application, a code block for retrieving the balance enquiry from a bank server, etc. Further, the extracted data elements of the balance enquiry functionality may include data artifacts such as balance enquiry data and a security pin to access the banking application. In an embodiment, the functionality 502 may be represented as per equation (15), given below:

$$F ( n ) = Data elements \{ DE 1 , DE 2 , DE 3 … DEh \} + Process elements \{ B 1 , B 2 , B … Bg \} \qquad equation ( 15 )$$

Referring now to FIG. 5B and FIG. 5C, exemplary tables 500B and 500C generated during determination of target elements from the functionality 502 of the monolithic application are illustrated, in accordance with some embodiments. FIGS. 5B-5C are explained in conjunction with FIGS. 1-5A.

The table 500B includes FA scores 508 corresponding to each of the set of process elements 504 and each of the set of data elements 506. The FA scores 508 may be determined for each of the set of process elements 504 and each of the set of data elements 506 extracted from the functionality 502 based on a first set of predefined attributes and a second set of predefined attributes respectively as explained earlier in detail in FIG. 2. For example, an FA score corresponding to “B1” is “40”, “B2” is “70”, “B3” is “90”, “B4” is “30”, “B5” is “80”, “B6” is “10”, “B7” is “0”, Bg is “50”, “DE1” is “30”, “DE2” is “80”, “DE3” is “90”, “DE4” is “20”, “DE 5” is “60”, “DE6” is “10”, “DE7” is “0”, and “DEh” is “30”.

Referring to FIG. 5C, the table 500C includes different categories 510 assigned to each of the set of process elements 504 and each of the set of data elements 506. The categories 510 include a reutilization category 510a, a modification category 510b, and a removal category 510c. A category from the categories 510 may be assigned to elements (process elements or data elements) based on their FA score and predefined threshold ranges. By way of an example, a predefined threshold range for the reutilization category 510a is 80 to 100, a predefined threshold range for the modification category 510b is 40 to 80, and a predefined threshold range for the removal category 510c is 0 to 40. Thus, based on such predefined threshold ranges, elements “B3”, “B5”, “DE2”, and “DE3” are assigned with the reutilization category 510a, elements “B2”, “Bg”, and “DE5” are assigned with the modification category 510b, and elements “B1”, “B4”, “B6”, “B7”, “DE1”, “DE4”, “DE6”, “DE7”, and “DEh” are assigned with the removal category 510c.

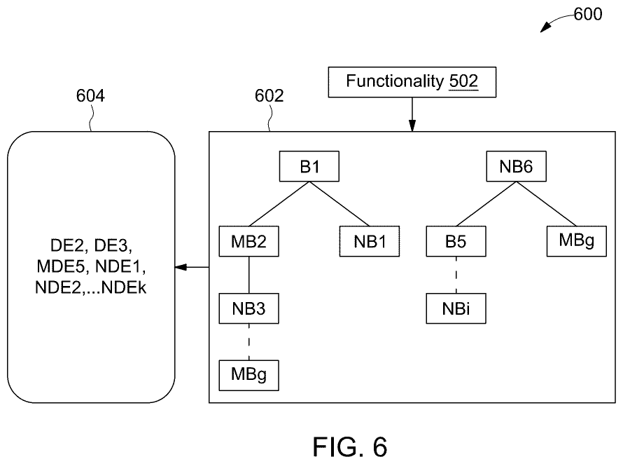

Referring now to FIG. 6, an exemplary functional flow 600 for the functionality 502 of the monolithic application is illustrated, in accordance with some embodiments. FIG. 6 is explained in conjunction with FIGS. 1-5A-5C. In an embodiment, elements “B1”, “B4”, “B6”, “B7”, “DE1”, “DE4”, “DE6”, “DE7”, and “DEh” assigned with the removal category 510c may be replaced by new elements, and elements “B2”, “Bg”, and “DE5” with the modification category 510b may be modified. For example, “B2” is modified as “MB2”, “Bg” is modified as “MBg”, and “DE5” is modified as “MDE5”. Replacements and modifications may be performed to include elements that have better FA scores with the functionality 502 of the monolithic application. Hence, target/core elements may be identified from the functionality 502 by considering elements (such as B3, B5, DE2, and DE3) with the reutilization category 510a, replacing the elements with the removal category (such as B1, B4, B6, B7, DE1, DE4, DE6, DE7, and DEh) with the new elements (such as NB1, NB2, NBj, NDE1, NDE2, NDEk), and considering the modified elements (such as MB2, MBg, and MDE5). It should be noted that the target/core elements of the functionality 502 may be identified based on a business context. Further, process elements 602 and data elements 604 of the target/core elements determined from the functionality 502 of the monolithic application are given as per equations (16) and (17), given below:

$$Process elements of the target elements = \{ B 3 , B 5 , MB 2 , MBn , NB 1 , NB 2 … NBn \} \qquad equation ( 16 )$$

$$Data elements of the target elements = \{ DE 2 , DE 3 , MDE 5 , NDE 1 , NDE 2 , … NDEn \} \qquad equation ( 17 )$$

In an embodiment, the target/core elements may be ordered to create the functional flow 600 related to the functionality 502 of the monolithic application. Dependencies may be used for ordering the target/core elements in the functional flow 600. It should be noted that one element may occur multiple times in the functional flow 600. Further, the target/core elements may be ordered in a way to represent the given functionality 502 in a technology and a framework. In some embodiments, the target/core elements may need to be transformed based on a target platform. The target platform may be, but not limited to, micro-services, functional documents, serverless functions, etc. Further, the target/core elements may be converted based on a syntax of the target platform along with a necessary non-functional requirement (NFR) for a final deployment. NFRs is a set of specifications that may describe monolithic application's operation capabilities and constraints and attempt to improve functionalities.

In an exemplary embodiment, the process elements 602 and the data elements 604 are ordered to create the functional flow 600. The process elements 602 and the data elements 604 are reordered in a way to optimize the functionality 502. For example, consider that the target platform is a microservice platform, then the process elements 602 and the data elements 604 are transformed based on the syntax and the NFR of the targeted micro-service platform.

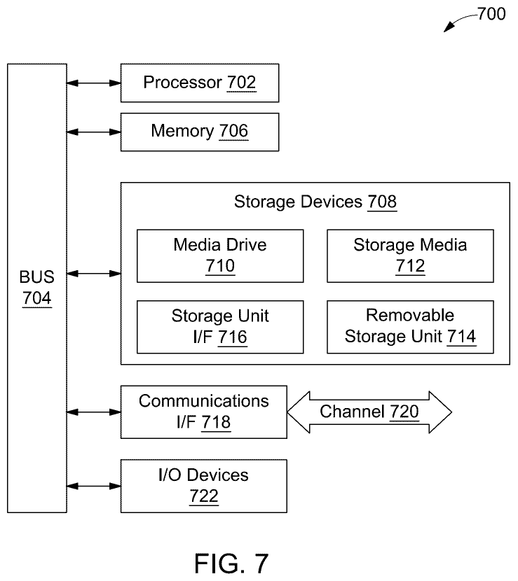

The disclosed methods and systems may be implemented on a conventional or a general-purpose computer system, such as a personal computer (PC) or server computer. Referring now to FIG. 7, an exemplary computing system 700 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 700 may represent, for example, a user device such as a desktop, a laptop, a mobile phone, personal entertainment device, DVR, and so on, or any other type of special or general-purpose computing device as may be desirable or appropriate for a given application or environment. The computing system 700 may include one or more processors, such as a processor 702 that may be implemented using a general or special purpose processing engine such as, for example, a microprocessor, microcontroller or other control logic. In this example, the processor 702 is connected to a bus 704 or other communication medium. In some embodiments, the processor 702 may be an Artificial Intelligence (AI) processor, which may be implemented as a Tensor Processing Unit (TPU), or a graphical processor unit, or a custom programmable solution Field-Programmable Gate Array (FPGA).

The computing system 700 may also include a memory 706 (main memory), for example, Random Access Memory (RAM) or other dynamic memory, for storing information and instructions to be executed by the processor 702. The memory 706 also may be used for storing temporary variables or other intermediate information during execution of instructions to be executed by the processor 702. The computing system 700 may likewise include a read only memory (“ROM”) or other static storage device coupled to bus 704 for storing static information and instructions for the processor 702.

The computing system 700 may also include a storage device 708, which may include, for example, a media drive 710 and a removable storage interface. The media drive 710 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 712 may include, for example, a hard disk, magnetic tape, flash drive, or other fixed or removable medium that is read by and written to by the media drive 710. As these examples illustrate, the storage media 712 may include a computer-readable storage medium having stored therein particular computer software or data.

In alternative embodiments, the storage devices 708 may include other similar instrumentalities for allowing computer programs or other instructions or data to be loaded into the computing system 700. Such instrumentalities may include, for example, a removable storage unit 714 and a storage unit interface 716, such as a program cartridge and cartridge interface, a removable memory (for example, a flash memory or other removable memory module) and memory slot, and other removable storage units and interfaces that allow software and data to be transferred from the removable storage unit 714 to the computing system 700.

The computing system 700 may also include a communications interface 718. The communications interface 718 may be used to allow software and data to be transferred between the computing system 700 and external devices. Examples of the communications interface 718 may include a network interface (such as an Ethernet or other NIC card), a communications port (such as for example, a USB port, a micro USB port), Near field Communication (NFC), etc. Software and data transferred via the communications interface 718 are in the form of signals which may be electronic, electromagnetic, optical, or other signals capable of being received by the communications interface 718. These signals are provided to the communications interface 718 via a channel 720. The channel 720 may carry signals and may be implemented using a wireless medium, wire or cable, fiber optics, or other communications medium. Some examples of the channel 720 may include a phone line, a cellular phone link, an RF link, a Bluetooth link, a network interface, a local or wide area network, and other communications channels.

The computing system 700 may further include Input/Output (I/O) devices 722. Examples may include, but are not limited to a display, keypad, microphone, audio speakers, vibrating motor, LED lights, etc. The I/O devices 722 may receive input from a user and also display an output of the computation performed by the processor 702. In this document, the terms “computer program product” and “computer-readable medium” may be used generally to refer to media such as, for example, the memory 706, the storage devices 708, the removable storage unit 714, or signal(s) on the channel 720. These and other forms of computer-readable media may be involved in providing one or more sequences of one or more instructions to the processor 702 for execution. Such instructions, generally referred to as “computer program code” (which may be grouped in the form of computer programs or other groupings), when executed, enable the computing system 700 to perform features or functions of embodiments of the present invention.

In an embodiment where the elements are implemented using software, the software may be stored in a computer-readable medium and loaded into the computing system 700 using, for example, the removable storage unit 714, the media drive 710 or the communications interface 718. The control logic (in this example, software instructions or computer program code), when executed by the processor 702, causes the processor 702 to perform the functions of the invention as described herein.

Thus, the disclosed method and system try to overcome the technical problem of determining the target/core elements from a functionality of a monolithic application. The method and system provide means to document a plurality of functionalities of the monolithic application. Further, the method and system may provide means to document code blocks and backend of the monolithic application. Further, the method and system provide a means to identify the target/core elements of a business functionality of a monolithic application. Further, the method and system may provide means to replace the elements with target elements. The method and system may create a functional flow for the functionality with the target elements based on element dependencies.

This disclosure provides an efficient tool for businesses which helps figure out the most important parts of how a business works and then documents them, especially when it comes to monoliths. For example, when it is required to move business functions to a different system, the disclosure makes it easy. The disclosure helps sorting out all the important elements in a way that works with any kind of technology and setup. Thus, the disclosure makes it possible to switch to a new system using specific templates that match the new setup. The disclosure provides a smart guide that makes sure that a business keeps running smoothly, no matter how technology changes.

As will be appreciated by those skilled in the art, the techniques described in the various embodiments discussed above are not routine, or conventional, or well understood in the art. The techniques discussed above provide for determining target elements from a functionality of a monolithic application. The techniques first extract a set of process elements and a set of data elements from the functionality of the monolith application. The set of process elements includes code snippets responsible for controlling an execution flow of processing the functionality, and wherein the set of data elements comprises entities within the code snippets. The techniques then determine a Functionality Association (FA) score for each element of the set of process elements based on a first set of predefined attributes, and each element of the set of data elements based on a second set of predefined attributes. The techniques then assign a category from a plurality of categories to each element of the set of process elements and the each element of the set of data elements based on the FA score and pre-defined threshold ranges. The techniques further determine the target elements based on the assigned category.

In light of the above mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for determining target elements from a functionality of a monolithic application. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of determining target elements from a functionality of a monolithic application, the method comprising:
extracting, by a computing device, a set of process elements and a set of data elements from the functionality of the monolith application;
determining, by the computing device, a Functionality Association (FA) score for each element of the set of process elements based on a first set of predefined attributes, and each element of the set of data elements based on a second set of predefined attributes;
assigning, by the computing device, a category from a plurality of categories to the each element of the set of process elements and the each element of the set of data elements based on the FA score and pre-defined threshold ranges; and
determining, by the computing device, the target elements based on the assigned category.

2. The method of claim 1, wherein the set of process elements comprises code snippets responsible for controlling an execution flow of processing the functionality, and wherein the set of data elements comprises entities within the code snippets.

3. The method of claim 1, wherein the plurality of categories comprises a reutilization category, a modification category, and a removal category.

4. The method of claim 3, wherein determining the target elements comprises:
selecting elements assigned with the reutilization category and the modification category;
discarding elements assigned with the removal category; and
replacing the discarded elements with one or more new elements to determine the target elements.

5. The method of claim 1, further comprising:
creating a functional flow for the functionality with the target elements based on element dependencies, wherein multiple occurrences of a target element are permitted in the functional flow; and
transforming the target elements into one or more formats of one or more target platforms based on the functional flow.

6. The method of claim 1, wherein the first set of predefined attributes comprises a Line of Code (LOC), a comment density, a cyclomatic complexity, a data artifact affinity, a data input, a data output, a frequency of invocations, element dependencies, annotations, technical dependencies, a number of classes, a frequency of changes, a historical analysis, and a documentation.

7. The method of claim 1, wherein the second set of predefined attributes comprises an association of data elements with the functionality, a level of ownership of the functionality with data elements, and dependencies among data elements.

8. The method of claim 1, wherein the set of process elements and the set of data elements are extracted through an automated crawling technique.

9. A system for determining target elements from a functionality of a monolithic application, the system comprising:
a processor; and
a memory communicatively coupled to the processor, wherein the memory stores processor-executable instructions, which, on execution, cause the processor to:
extract a set of process elements and a set of data elements from the functionality of the monolith application;
determine a Functionality Association (FA) score for each element of the set of process elements based on a first set of predefined attributes, and each element of the set of data elements based on a second set of predefined attributes;
assign a category from a plurality of categories to each element of the set of process elements and each element of the set of data elements based on the FA score and pre-defined threshold ranges; and
determine the target elements based on the assigned category.

10. The system of claim 9, wherein the set of process elements comprises code snippets responsible for controlling an execution flow of processing the functionality, and wherein the set of data elements comprises entities within the code snippets.

11. The system of claim 9, wherein the plurality of categories comprises a reutilization category, a modification category, and a removal category.

12. The system of claim 11, wherein the processor-executable instructions further cause the processor to determine the target elements by:
selecting elements assigned with the reutilization category and the modification category;
discarding elements assigned with the removal category; and
replacing the discarded elements with one or more new elements to determine the target elements.

13. The system of claim 9, wherein the processor-executable instructions further cause the processor to:
create a functional flow for the functionality with the target elements based on element dependencies, wherein multiple occurrences of a target element are permitted in the functional flow; and
transform the target elements into one or more formats of one or more target platforms based on the functional flow.

14. The system of claim 9, wherein the first set of predefined attributes comprises a Line of Code (LOC), a comment density, a cyclomatic complexity, a data artifact affinity, a data input, a data output, a frequency of invocations, element dependencies, annotations, technical dependencies, a number of classes, a frequency of changes, a historical analysis, and a documentation.

15. The system of claim 9, wherein the second set of predefined attributes comprises an association of data elements with the functionality, a level of ownership of the functionality with data elements, and dependencies among data elements.

16. The system of claim 9, wherein the set of process elements and the set of data elements are extracted through an automated crawling technique.

17. A non-transitory computer-readable medium storing computer-executable instructions for determining target elements from a functionality of a monolithic application, the computer-executable instructions configured for:
extracting a set of process elements and a set of data elements from the functionality of the monolith application;
determining a Functionality Association (FA) score for each element of the set of process elements based on a first set of predefined attributes, and each element of the set of data elements based on a second set of predefined attributes;
assigning a category from a plurality of categories to each element of the set of process elements and each element of the set of data elements based on the FA score and pre-defined threshold ranges; and
determining the target elements based on the assigned category.

18. The non-transitory computer-readable medium of claim 17, wherein the plurality of categories comprises a reutilization category, a modification category, and a removal category.

19. The non-transitory computer-readable medium of claim 18, wherein determining the target elements comprises:
selecting elements assigned with the reutilization category and the modification category;
discarding elements assigned with the removal category; and
replacing the discarded elements with one or more new elements to determine the target elements.

20. The non-transitory computer-readable medium of claim 17, wherein the computer-executable instructions are configured for:
creating a functional flow for the functionality with the target elements based on element dependencies, wherein multiple occurrences of a target element are permitted in the functional flow; and
transforming the target elements into one or more formats of one or more target platforms based on the functional flow.
